(19) United States
(12) Patent Application Publication
(10) Pub. No.: US 2015/0358716 A1
(43) Pub. Date: Dec. 10, 2015

(54) A TENSION DETECTION-BASED HEADSET WITH INTELLIGENT SWITCHING CONTROL

(71) Applicants: INNOVATION SOUND TECHNOLOGY CO., LTD., Shenzhe, Guangdong (CN); LEAGUER XINYUAN SMART CONTROL TECHNOLOGY CO., LTD., Shenzhen, Guangdong (CN)

(72) Inventors: Huizhong ZHU, Shenzhen, Guangdong (CN); Xinming YUAN, Shenzhen, Guangdong (CN); Zhengyun ZHOU, Shenzhen, Guangdong (CN); Wenxuan HUANG, Shenzhen, Guangdong (CN)

(21) Appl. No.: 14/759,812

(22) PCT Filed: Jan. 11, 2013
(86) PCT No.: PCT/CN2013/070347

§ 371 Date: Jul. 8, 2015

(51) Int. Cl. H04R 1/10

(52) U.S. Cl. CPC H04R 1/1041

(57) ABSTRACT

A type of tension detection-based headset with intelligent switching control is disclosed in the invention, which comprises a head wearing yoke and headphone speakers connected at the two ends of the head wearing yoke, inside the head wearing yoke a piece of elastic sheet steel is disposed further on which a force sensor is disposed. The said force sensor obtains a message in relation to the deformation of the elastic sheet steel by detecting any deformation of the said built-in elastic sheet steel and outputs a switch signal, after being processed by the measuring circuit, to the switch module which initiates automatic control according to the switch signal. The invention is for intelligent on-off control of the headphone which can be automatically turned on when worn on the head and automatically turned of when taken off, thereby elevating user convenience and reducing unnecessary power consumption.

### FIELD OF THE INVENTION

The present invention relates to a type of headphone, more specifically, a type of tension detection-based headset with intelligent switching control.

### BACKGROUND OF THE INVENTION

Earphone is a personal sound player widely used in audio-visual arrangements and communication equipment which converts sound source signals into sound to be heard by the user. Earphone can be divided into earphone and headphone by the structural type, wherein the former features a small size, light weight and needs to be plugged in the ear canal, while the latter usually comprises a hanger and two earmuff speakers with built-in sounding means and features a bigger size with two earmuffs covering the auricle to introduce sound into the ear canal. Earphone can also cut off external noise to obtain the best sound effects.

Large power consumption will be involved in vocal state when electrical signal drive is needed to generate a sound signal while the earphone is operating. The earphone had better to be turned off to save electric power while it is not in use or is taken off from the head. Manual operation will always be involved regardless of whether to set the earphone switch or unplug the earphone from the sound source jack. The earphone will be left in operating state in case the user forgets to either operate the switch or unplug the earphone from the sound source jack.

This is particularly evident for earphones with an independent power supply, those with Bluetooth and denoiser functions in particular, and a great load of unnecessary power consumption will be incurred if not controlled. Typically, the earphone device is to be disposed a mechanical switch by operating Which switchover between active and standby (on/off) mode can be realized. The device might be left in long-term operating state in case the user forgets to operate such a switch and continuous power consumption will result.

An earphone-specific intelligent switch control system is disclosed in Chinese Patent 200610074142.8, which employs electrically conductive earplugs to be plugged inside the ear canal and get in touch with human body to produce a signal change of the capacitive sensor disposed inside the earphone, thereby judging if the speakers have been plugged in or withdrawn from the user ear canals and accordingly controlling the earphone in active or standby status. This method can greatly elevate the user convenience. The earphone is on when plugged in and off when withdrawn, yet this art is for the use of earphone system only.

A headphone-specific intelligent switch control system is disclosed in Chinese Patent 201120181855.0, which disposes a human proximity sensor on the headphone. When the headphone is worn, the sensor detection circuit detects headphone proximity to human body, thereby judging if the headphone is already in use, namely controlling the voice-frequency circuit in on state.

### DESCRIPTION OF THE INVENTION

The technical problem to be solved by the invention is to provide a tension detection-based headset with intelligent switching control by introducing a sensor to detect the yoke deformation per the phenomenon that elastic components in the yoke will be subject to elastic deformation as the headphone opens while it is in use to judge if the headphone is in use and then automatically turning on or off the headphone power supply.

The technical scheme to be adopted to solve the technical problem of the invention is such that: a type of tension detection-based headset with intelligent switching control comprising a head wearing yoke and headphone speakers connected at two ends of the said head wearing yoke is constructed, which is characterized in that: inside the head wearing yoke a piece of elastic sheet steel is disposed further on which a force sensor is disposed; when the headphone is worn, the speakers on both sides open so that the said elastic sheet steel is subject to elastic deformation and then a moderate elastic restoring force is generated to press the headphone tightly against the head and the auricle; the said force sensor obtains a message in relation to the deformation of the elastic sheet steel by detecting any deformation of the said built-in elastic sheet steel and outputs a switch signal, after being processed by the measuring circuit, to the switch module which initiates automatic control according to the switch signal.

The tension detection-based headset with intelligent switching control as claimed in the invention is characterized in that, the said force sensor could be a set of resistance strain gages attached onto the said elastic sheet steel; the said set of resistance strain gages includes at least a sensitive resistance strain gage whose sensitivity direction is consistent with the stress direction of the said elastic sheet steel and which is used to detect elastic deformation on the surface of the said elastic sheet steel; the said set of resistance strain gages constitutes a measuring bridge connected to the measuring circuit which monitors stress change of the said headphone speakers by detecting voltage change output by the measuring bridge, thereby judging the use state of the headphone and controlling the switch module for correct on-off control.

The tension detection-based headset with intelligent switching control as claimed in the invention is characterized in that the said force sensor could be an independent resistance strain gage which is attached onto the said elastic sheet steel along whose stress direction and connected to the measuring circuit which monitors stress change of the said headphone speakers by detecting resistance variation of the said resistance strain gage, thereby judging the use state of the headphone and controlling the switch module for correct on-off control.

The tension detection-based headset with intelligent switching control as claimed in the invention is characterized in that, the said force sensor could be a unique full-bridge resistance strain gage, wherein: two resistance strain gages on adjacent bridge arms of the said full-bridge resistance gage are in perpendicular sensitivity direction, while two resistance strain gages on opposite bridge arms of the said full-bridge resistance strain gage are in same sensitivity direction and perpendicular to the sensitivity direction of the counterparts on another pair of bridge arm; the said full-bridge resistance strain gage is taken per the sensitivity direction of one of its resistance strain gages and attached onto the said elastic sheet steel along whose stress direction and then connected to the measuring circuit to obtain a differential bridge output consistent with the stress level of the said headphone speakers.

The tension detection-based headset with intelligent switching control as claimed in the invention is characterized in that the said measuring control circuit comprises an amplifier, an A/D converter, a microcontroller and a switch module, etc.

The tension detection-based headset with intelligent switching control as claimed in the invention is characterized in that the said force sensor could be disposed on the external surface of the said elastic sheet steel. It could as well be disposed on the inner surface of the said elastic sheet steel. The direction of stress change is different on the inner and external surface of the elastic sheet steel, yet the change could serve to judge if the headphone is in use.

Application of the tension detection-based headset with intelligent switching control as claimed in the invention could render beneficial effects as follows: the force sensor disposed on the elastic sheet steel inside the head wearing yoke of the headphone is used to detect the acting force on the headphone speakers and sense the action of putting on or taking off the headphone, thereby judging if the headphone is worn on the user's head for intelligent on-off control of the headphone. The headphone is on when Worn and off when taken off and no manual operation whatsoever is required, thus achieving the win-win effect of greatly elevating user convenience and reducing unnecessary power consumption.

### BRIEF INTRODUCTION OF THE DRAWINGS

FIG. 1 is a free-state schematic view of the tension detection-based headset with intelligent switching control as claimed in the invention.

FIG. 2 is a free-body schematic view of the tension detection-based headset with intelligent switching control as claimed in the invention when worn on the head.

FIG. 3a is a free-body schematic view of the elastic sheet steel disposed inside the head wearing yoke of the tension detection-based headset with intelligent switching control as claimed in the invention.

FIG. 3b is a schematic view of the force sensor of the tension detection-based headset with intelligent switching control as claimed in the invention.

FIG. 4a is a schematic view of the first embodiment of the resistance strain gage used as the force sensor of the tension detection-based headset with intelligent switching control as claimed in the invention.

FIG. 4b is a schematic view of the second embodiment of the resistance strain gage used as the force sensor of the tension detection-based headset with intelligent switching control as claimed in the invention.

FIG. 5 is a circuit schematic view of the tension detection-based headset with intelligent switching control as claimed in the invention.

Wherein:
100—head wearing yoke
200—headphone speaker
300—lead
400—plug
101—elastic sheet steel inside head wearing yoke
102—force sensor

### DETAILED DESCRIPTION OF THE PREFERRED EMBODIMENTS

To make the purpose, technical scheme and advantages of the invention even clearer, a further detailed description will be made hereinafter according to the accompanying drawings and embodiments. It shall be understood that the foregoing descriptions of the embodiments are intended to illustrate and not to limit this invention.

As shown in FIG. 1 the free-state schematic view of the tension detection-based headset with intelligent switching control as claimed in the invention which comprises a head wearing yoke 100 and headphone speakers 200 connected at two ends of the said head wearing yoke, the said headphone can be connected to the sound source (which could be a computer, a mobile phone, a laptop, a MP3, etc.) through the lead 300 and the plug 400; the said headphone could be connected to the sound source through wireless means as well, namely, a RF transceiver/receiver module is added in the headphone to receive audio signals sent from the sound source, which requires for neither the lead 300 nor the plug 400 but a RF transceiver/receiver module is to be disposed at the sound source end.

To ensure the headphone is stable when worn and does not escape during use, it shall be such that a certain pressing force is applied on the user's head (or auricle) and the auricle in return exerts a certain counter-acting force on the speakers when the headphone is worn, so that the speakers on both sides tend to open. Such an acting force is realized technically by disposing a piece of elastic sheet steel inside the headphone yoke. In free state, two speakers are close to each other, the elastic sheet steel inside the yoke is in free state and there is no stress inside; when worn on the head, two speakers are drawn apart and the acting force of bead (or auricle) on two speakers is transmitted onto the elastic sheet steel inside the head wearing yoke so that it is bent and deformed. In accordance with the mechanical theory, elongating or shortening elastic strain will occur on the upper and lower surfaces of a long-strip elastomer When it is subject to a bending load. Obviously, elastic bending deformation when the headphone is worn and when the elastic sheet steel inside the yoke is subject to a tension force co-occurs and the use state of the headphone can be sensed by employing some kind of measuring means to measure such a tension force or deformation.

As shown in FIG. 2, when the said headphone is worn, the speakers 200 on both sides will be subject to the acting force F of the auricle so that the yoke 100 tends to open.

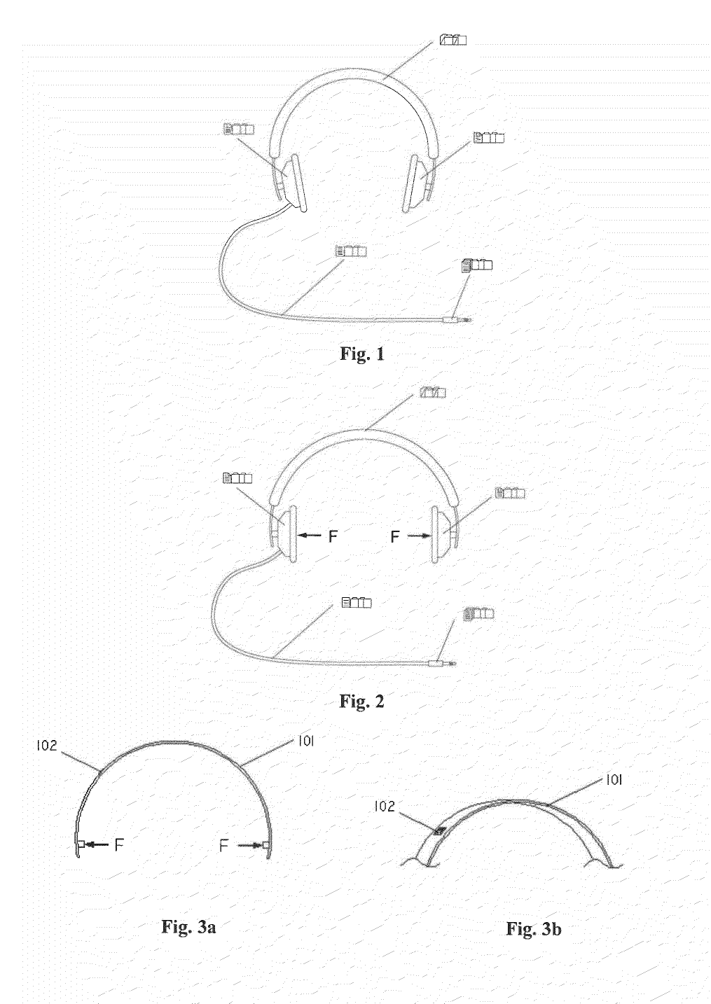

As shown in FIG. 3a and FIG. 3b, inside the yoke 100 of the said headphone a piece of elastic sheet steel 101 is disposed further on which a force sensor is disposed which obtains a message in relation to the deformation of the elastic sheet steel by detecting any deformation of the built-in elastic sheet steel and outputs a switch signal, after being processed by the measuring circuit, to the switch module which initiates automatic control according to the switch signal. Specifically, the said force sensor is the resistance strain gage 102 which could be disposed either on the external surface or the inner surface of the elastic sheet steel 101 or attached on both the external surface and the inner surface. The said resistance strain gage 102 measures the extent of deformation of the elastic sheet steel 101 when it is subject to a tension force.

The elastic sheet steel 101 is made of steels of excellent resilience. The resistance strain gage is attached wherever suitable on the surface of the elastic sheet steel along the stress direction of the yoke to constitute the force sensor for real-time measurement of the force on two speakers. A certain load threshold is selected according to the corresponding relationship between deformation and acting force in the actual structure. The headphone is deemed worn when the acting force on two speakers is higher than the set threshold, which is a hint that the voice-frequency circuit switch should be turned on promptly to start the headphone; conversely, the headphone is deemed taken off when the acting force on two speakers is lower than the set threshold, which is a hint that the headphone is in free state and should be turned off promptly.

The said force sensor could be a set of resistance strain gages 102 attached onto the elastic sheet steel; the said set of resistance strain gages includes at least a sensitive resistance strain gage whose sensitivity direction is consistent with the stress direction of the said elastic sheet steel and which is used to detect elastic deformation on the surface of the said elastic sheet steel; the said set of resistance strain gages constitutes a measuring bridge connected to the measuring circuit which monitors stress change of the said headphone speakers by detecting voltage change output by the measuring bridge, thereby judging the use state of the headphone and controlling the switch module for correct on-off control.

In the invention, the force on the elastic sheet steel is measured by measuring the strain on its surface; the resistance strain gage is electrically a rheostat and the strain-sensitive element a sensitive wire grid. The resistance strain gage is attached onto the elastomer surface with a special type of glue and then consolidated with the elastic sheet steel whose surface strain when stressed makes the wire grid of the resistance strain gage elongate or shorten and the resistance increase or decrease accordingly. Indirect measurement of the load on the elastic sheet steel can be made when connected to the measuring circuit to measure the resistance variation.

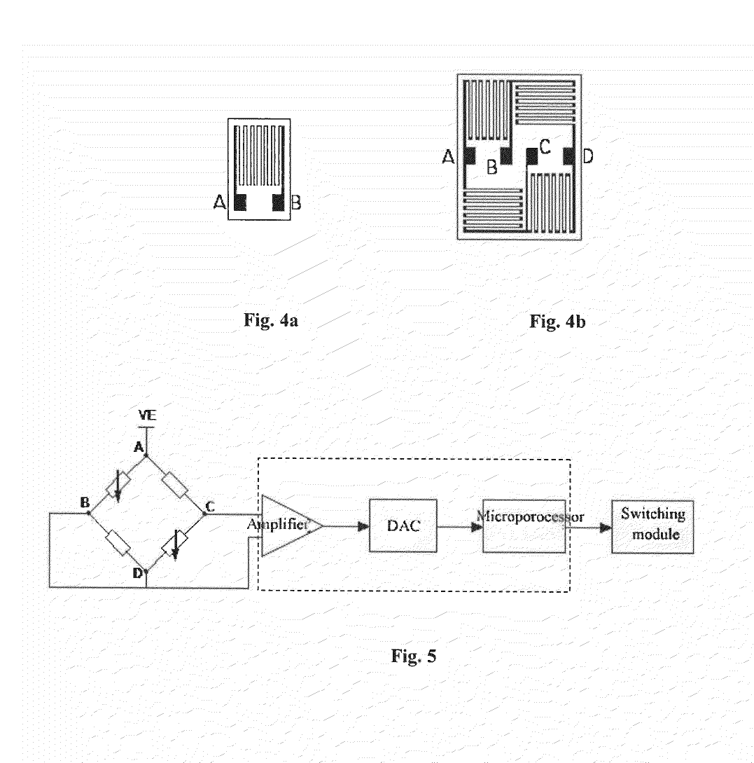

As shown in FIG. 4a, the resistance strain gage 102 could be a one-chip resistance strain gage.

As shown in FIG. 4b, the resistance strain gage 102 could be a full-bridge resistance strain gage as well.

As shown in FIG. 5, the resistance strain gage 102 is connected into a wheatstone bridge through the lead and then connected to the measuring circuit. Differential output ends B and C of the bridge are connected to the differential amplifier circuit for signal amplification. Sampling and computing are made by the microcontroller after A/D conversion to analyze if the load F on the speakers 200 is over the preset threshold, thereby judging if the headphone is to be turned on or off.

As shown in FIG. 5, the bridge used for the measurement of resistance strain signal comprises four arms, namely RAB, RBD, RAC and RCD. Differential voltage (VB−VC) is output at another pair of nodes B and C when a regulated voltage VE is applied on one pair of nodes A and D of the bridge. Resistance variation of either arm of the bridge will be reflected in the change of the differential output voltage (VB−VC).

As the first embodiment of the invention, the resistance strain gage 102 used for force measurement is designed into a full-bridge resistance strain gage as shown in FIG. 4b. To realize differential output signal, RAB and RCD out of the four arms are designed into a sensitive chip, while the other two RBD and RAC are designed into a non-sensitive chip and the sensitivity direction of their wire grid is perpendicular to RAB and RCD. When attached onto the elastic sheet steel 101, the sensitivity direction of the wire grid (i.e., lengthwise direction of the wire grid) of the two sensitive arms RAB and RCD is consistent with the stress direction of the said elastic sheet steel 101, while that of the other two arms RBD and RAC is perpendicular to the stress direction of the said elastic sheet steel 101. When the headphone is worn, the said elastic sheet steel 101 is deformed by bending under the outer tension force F, its external surface is deformed by compression along the arc lengthwise direction, the wire grid of two sensitive arms RAB and RCD shortens, and the resistance value decreases; the wire grid of the other two arms RBD and RAC, however, is not subject to strain since its direction is perpendicular to the stress direction and the resistance value varies in no way. It is reflected in the bridge as shown in FIG. 5 such that, RAB and RCD decrease while RBD and RAC remain unchanged, resulting in VB increase and VC decrease, hence a change in the differential output. The force F on the speakers on both sides can be detected by detecting such a change.

As the second embodiment of the invention, the said resistance strain gage 102 for force measurement could as well be a single-chip resistance strain gage as shown in FIG. 4a. When attached onto the elastic sheet steel 101, the resistor RAB varies with the force F on the speakers on both sides. The said single-chip resistance strain gage RAB constitutes the measuring bridge as shown in FIG. 5 together with another three fixed resistors RBD, RAC and RCD whose resistance value is equivalent to it. Node voltage VB will change with the force on the speakers on both sides, while the other node voltage VC will remain constant for differential output (VB−VC). A microcontroller is provided to measure and judge the force on the speakers both sides, thereby realizing intelligent on-off control of the headphone.

Obviously, given a same structure of the resistance strain gage and under same exciting voltage VE conditions, the signal strength obtained in the first embodiment is one times higher than that as obtained in the second embodiment and slightly lower requirements are put on the measuring circuit.

Rational design of the structure and the position to be attached on the said elastic sheet steel 101 of the sensitive resistance strain gage 102 is the key to the intelligent control method of the invention, so as to obtain good output signal change of the bridge for measurement and judgment. When the said elastic sheet steel 101 is subject to the outer tension force as shown in FIG. 3a, the elastic sheet steel 101 is deformed by outward bending, with its external surface subject to a compressive stress and its inner surface to a tensile stress. For the intelligent control function of the invention, the resistance strain gage 102 could as well be attached on the inner surface or even on both the inner surface and the external surface to obtain even stronger differential Signal output of the bridge. However, regardless of in what structure, by what quantity and in what manner the resistance strain gage 102 is attached onto the said elastic sheet steel 101, it is all but refinement of the intelligent on-off control method of the headphone as claimed in the invention. The acting force F on the speakers 200 of the said headphone is detected to judge if the headphone is worn, thereby realizing intelligent on-off control.

To sum up, notwithstanding that the art of the invention is described in detail through embodiments, it shall be understood by those skilled in the art that the foregoing embodiments are intended to describe the preferred embodiments only and not to limit the scope of protection of the invention. Any changes that could be readily reckoned within the disclosed scope of art of the invention by those skilled in the art are all covered within the scope of protection of the invention.

1. A type of tension detection-based headset with intelligent switching control comprising a head wearing yoke and headphone speakers connected at two ends of the said head wearing yoke is disclosed in the invention, which is characterized in that: inside the head wearing yoke a piece of elastic sheet steel is disposed further on which a force sensor is disposed; when the headphone is worn, the speakers on both sides open so that the said elastic sheet steel is subject to elastic deformation and then a moderate elastic restoring force is generated to press the headphone tightly against the head and the auricle; the said force sensor obtains a message in relation to the deformation of the elastic sheer steel by detecting any deformation of the said built-in elastic sheet steel and outputs a switch signal, after being processed by the measuring circuit, to the switch module which initiates automatic control according to the switch signal.

2. The tension detection-based headset with intelligent switching control according to claims 1 is characterized in that the said force sensor is a set of resistance strain gages attached onto the said elastic sheet steel; the said set of resistance strain gages includes at least a sensitive resistance strain gage which is whose sensitivity direction is consistent with the stress direction of the said elastic sheet steel and which is used to detect elastic deformation on the surface of the said elastic sheet steel; the said set of resistance strain gages constitutes a measuring bridge connected to the measuring circuit which monitors stress change of the said headphone speakers by detecting voltage change output by the measuring bridge, thereby judging the use state of the headphone and controlling the switch module for correct on-off control.

3. The tension detection-based headset with intelligent switching control according to claims 1 is characterized in that the said force sensor is an independent resistance strain gage which is attached onto the said elastic sheet steel along whose stress direction and connected to the measuring circuit which monitors stress change of the said headphone speakers by detecting resistance variation of the said resistance strain gage, thereby judging the use state of the headphone and controlling the switch module for correct on-off control.

4. The tension detection-based headset with intelligent switching control according to claims 1 is characterized in that the said force sensor is a unique full-bridge resistance strain gage, wherein: two resistance strain gages on adjacent bridge arms of the said full-bridge resistance gage are in perpendicular sensitivity direction, while two resistance strain gages on opposite bridge arms of the said full-bridge resistance strain gage are in same sensitivity direction and perpendicular to the sensitivity direction of the counterparts on another pair of bridge arm; the said full-bridge resistance strain gage is taken per the sensitivity direction of one of its resistance strain gages and attached onto the said elastic sheet steel along whose stress direction and then connected to the measuring circuit to obtain a differential bridge output consistent with the stress level of the said headphone speakers.

5. The tension detection-based headset with intelligent switching control according to claims 1 is characterized in that, the said measuring circuit comprises an amplifier, an A/D converter connected to the amplifier and a microcontroller connected to the A/D converter, wherein the said microcontroller is connected to the switch module.

6. The tension detection-based headset with intelligent switching control according to claims 1 is characterized in that the said force sensor is disposed on the external surface of the said elastic sheet steel.

7. The tension detection-based headset with intelligent switching control according to claims 1 is characterized in that the said force sensor is disposed on the inner surface of the said elastic sheet steel.
